(19) United States
(12) Patent Application Publication
(10) Pub. No.: US 2012/0188922 A1
(43) Pub. Date: Jul. 26, 2012

(54) Enhanced Power Saving Mode for a Mobile Station

(76) Inventors: Yan Qun Le, Beijing (CN); Yi Wu, Beijing (CN)

(21) Appl. No.: 13/063,252

(22) PCT Filed: Sep. 12, 2008
(86) PCT No.: PCT/EP2008/062197

§ 371 Date: Jun. 3, 2011

(51) Int. Cl. H04W 52/02; H04W 4/06

(52) U.S. Cl. 370/311; 455/574; 455/418

(57) ABSTRACT

It is described a method for operating a mobile station within a telecommunication network. The method includes (a) providing a first power saving procedure for the mobile station wherein the first power saving procedure includes an alternating sequence of first sleep windows and first listening windows, (b) providing a second power saving procedure for the mobile station wherein the second power saving procedure includes an alternating sequence of second sleep windows and second listening windows, (c) adjusting on the time axis the first sleep windows and the second sleep windows with respect to each other in such a manner, that a time overlap between the first sleep windows and the second sleep windows is increased, and (d) operating the mobile station in an adjusted mode, which is defined by the increased time overlap. It is further described a mobile station, and a base station, which are adapted for executing the described method.

### FIELD OF INVENTION

The present invention relates to the field of telecommunication networks. In particular, the present invention relates to a method for operating a mobile station within a telecommunication network in an enhanced power saving mode. Further, the present invention relates to a mobile station being adapted to carry out the described method. Furthermore, the present invention relates to a base station and to a computer program, which are all adapted to trigger a mobile station to carry out the described method.

### ART BACKGROUND

For a mobile station (MS) in particular two factors determine its operation time. A first factor is the electrical performance of a battery being used. The second factor is the power consumption of the MS. Since it is very convenient for a user if his MS allows for a long operation time, apart from increasing the electrical performance of batteries, large effort has also been made in order to decrease the power consumption of mobile stations.

One important measure for decrease the power consumption of mobile stations is the introduction of a sleep modus, wherein sleep windows (SW) and listening windows (LW) are provided on the time axis. During the SW components of the MS, which components are related to the reception and the transmission of radio signals, are switched off or put in an idle state. During the LW components of the MS, which components are related to the transmission of radio signals, are switched off or put in an idle state. By incorporating SL and LW the power consumption of the MS can be reduced effectively.

For a Wimax telecommunication system different types of data delivery services are defined. Further, different power saving classes are defined, which are preferentially used in connection with one of the defined types of data delivery services. These definitions are described in the following specifications:

### a) IEEE 802.16-2004, “IEEE Standard for Local and Metropolitan Area Networks—Part 16: Air Interface for Fixed Broadband Wireless Access Systems, Jun. 24, 2004”

b) IEEE 802.16e-2005, “IEEE Standard for Local and Metropolitan Area Networks—Part 16: Air Interface for Fixed Broadband Wireless Access Systems, Feb. 28, 2006”

### 1. Data Delivery Services Defined in the Specification 802.16e:

In order to support multimedia services with variable requirements of qualify of service (QoS) in IEEE 802.16e systems, five types of data delivery services are defined:

a) unsolicited grant service (UGS)
b) real-time variable rate service (RT-VR)
c) extended real-time variable rate service (ERT-VR)
d) non-real-time variable rate service (NRT-VR)
e) best effort service (BE).

The UGS is used to support real-time applications with fixed rate data. The RT-VR is used to support real-time data applications with variable data rates which require a guaranteed data rate and a guaranteed delay. For the uplink direction, the RT-VR connections should be supported by a real-time Polling Service (rtPS) scheduling service. The ERT-VR service is used to support real-time applications with variable data rates which require guaranteed data rate and a guaranteed delay. For the uplink direction, the ERT-VR connections should be supported by extended real-time Polling Service (ertPS) scheduling service. The NRT-VR service is used to support applications that require a guaranteed data rate but are insensitive to delays. The BE service is used to support applications with no rate or delay requirements.

### 2. Sleep Modes Defined in the Specification 802.16e:

As has already been mentioned above, different sleep modes have been specified in order to minimize the MS power consumption. Further, the different sleep modes also contribute in decreasing the usage of the air interface resources of a serving base station (BS). A sleep mode is an operational state in which an MS conducts pre-negotiated periods of absence from the serving BS air interface. These periods are characterized by the unavailability of the MS, as observed from the serving BS. This holds both for downlink (DL) and uplink (UL) traffic.

For each involved MS, the BS keeps one or several context information, wherein each context information is related to a certain power saving class. A power saving class is a group of connections that have common demand properties. For example, all BE and NRT-VR connections may be marked as belonging to a single class while two UGS connections may belong to two different classes in case they have different intervals between consequent allocations. A PSC may be repeatedly activated and deactivated. The activation of certain PSC means that a predefined sequence of sleep windows (SW) and listening windows (LW) is started, which sequence is associated with the certain PSC.

Currently there are three types of PSC in defined in the specification 802.16e. These types differ by their respective parameter sets, their procedures of activation and deactivation, and their policies regarding the MS availability for data transmission.

### A) PSC Type I

In the PSC of type I an initial-sleep window SWᵢₙᵢ is specified for the first sleep interval and each next sleep window is twice the size of the previous one. However, no sleep window is longer than a final sleep window SWₘₐₓ, which is specified by the following equation (1):

SWₘₐₓ=SWbase·2^{SW exp} (1)

Thereby, SWmax, SWbase and SWexp are given as multiples of one frame, which represents an elementary time interval for time division multiplexing. The sleep windows (SL) are interleaved with constant-size listening windows (LW). During the active state of the PSC type I, the respective MS is not expected to send or receive any MAC Service Data Units (MSDUs) or their fragments or to send bandwidth requests for connections that belong to the power saving class type I.

The PSC of type I is recommended for BE type and NRT-VR type connections.

### B) PSC Type II

In the PSC of type II all sleep windows (SW) are of the same size as an initial window. The SW are interleaved with listening windows (LW) having a fixed duration. As opposite to PSC type I, during the LW of PSC type II the MS may send or receive any MSDUs or their fragments at connections comprising the PSC as well as acknowledgements to them. The MS shall not receive or transmit MSDUs during sleep windows.

The PSC of type II is recommended for connections of the UGS type, the RT-VR type and the ERT-VR type.

### C) PSC Type III

In the PSC of type III there are provided only sleep windows (SW) and no listening windows (LW). The duration of the SW is specified by the following equation (2):

SW=SWbase·2^{SW exp} (1)

Thereby, SWbase and SWexp are again given as multiples of one frame, which represents an elementary time interval for time division multiplexing. After an expiration of the SW the power saving class automatically becomes inactive.

The PSC of type III is recommended for multicast connections as well as for management operations.

In case an MS uses different power saving procedures, which might be assigned to one or more types of Power Saving Classes, the MS will be unavailable only within a time interval that does have no overlap with any listening window of any active power saving procedure. Further, the availability interval is a time interval that does not have any overlap with any unavailability interval, during which a serving BS shall not transmit to the MS. Therefore, only within the unavailability interval the MS may power down one or more physical operation components. As a consequence, the energy consumption of a battery-powered MS will be decreased.

Since in case of a usage of different power saving procedures the MS will only be unavailable within a time interval that does have no overlap with any listening window of any active power saving procedure, the efficiency of power saving might be reduced. Therefore, there might be a need for improving the reduction of the power consumption of a MS, which uses different power saving procedures.

### SUMMARY OF THE INVENTION

This need may be met by the subject matter according to the independent claims. Advantageous embodiments of the present invention are described by the dependent claims.

According to a first aspect of the invention there is provided a method for operating a mobile station within a telecommunication network. The provided method comprises (a) providing a first power saving procedure for the mobile station, wherein the first power saving procedure comprises an alternating sequence of first sleep windows and first listening windows, (b) providing a second power saving procedure for the mobile station, wherein the second power saving procedure comprises an alternating sequence of second sleep windows and second listening windows, (c) adjusting on the time axis the first sleep windows and the second sleep windows with respect to each other in such a manner, that a time overlap between the first sleep windows and the second sleep windows is increased, and (d) operating the mobile station in an adjusted mode, which is defined by the increased time overlap.

This first aspect of the invention is based on the idea that by synchronizing the cycles of different power saving procedures in a constructive manner the length of an unavailability interval of the mobile station (MS) can be increased. As a consequence, the energy consumption of the MS can be decreased accordingly.

Generally speaking, the described method defines a cycle synchronizing approach for a sleep mode management which covers different power saving procedures. Thereby, different data delivery services can be assigned to different power saving procedures.

A sleep window (SW) is a period of time, in which for a particular data delivery service the MS is absent for a serving base station (BS). Within this time window the MS may power down one or more physical operation components. A listening window (LW) is a period of time, in which the MS is ready for receiving data from the BS. This means that within this time window at least those components of the MS are activated, which are related to the reception of radio data.

It has to be mentioned that typically the time distributions of the sleep windows and the listening windows are complementary with respect to each other. Therefore, it is also possible to adjust on the time axis the first listening windows and the second listening windows relative to each other in such a manner, that a time overlap between the first sleep windows and the second sleep windows is increased.

Increasing the time overlap between the first sleep windows and the second sleep windows means that a final time overlap after the described method has been carried out is at least slightly larger than an initial time overlap before the described method has been carried out.

According to an embodiment of the invention the time overlap between the first sleep windows and the second sleep windows is maximized. This may provide the advantage that with respect to the possibility to deactivate or to power down components of the MS an optimal unavailability interval of the MS can be achieved, which comprises a maximal duration. As a positive consequence a maximal reduction of the energy consumption of the MS can be realized.

According to a further embodiment of the invention a first quality of service requirement for a first data delivery service being associated with the first power saving procedure and/or a second quality of service requirement for a second data delivery service being associated with the second power saving procedure is taken into account when adjusting on the time axis the first sleep windows and the second sleep windows with respect to each other. This may mean that quality of service requirements can be kept satisfied during the described adjustment procedure.

According to a further embodiment of the invention the method further comprises providing at least one further power saving procedure for the mobile station, wherein the further power saving procedure comprises an alternating sequence of further sleep windows and further listening windows, wherein on the time axis the first sleep windows, the second sleep windows and the further sleep windows are adjusted with respect to each other in such a manner, that a time overlap between the first sleep windows, the second sleep windows and the further sleep windows is increased. This may provide the advantage that not only two but three or even more power saving procedures can be synchronized with each other in order to increase and/or to maximize the duration of the time interval, during which the MS will not be available.

According to a further embodiment of the invention the telecommunication network is a Worldwide Interoperability for Microwave Access telecommunication network.

The Worldwide Interoperability for Microwave Access (WiMAX) telecommunication network is specified for instance in the publication IEEE 802.16-2004, “IEEE Standard for Local and Metropolitan Area Networks—Part 16: Air Interface for Fixed Broadband Wireless Access Systems, Jun. 24, 2004” and in the publication IEEE 802.16e-2005, “IEEE Standard for Local and Metropolitan Area Networks—Part 16: Air Interface for Fixed Broadband Wireless Access Systems, Feb. 28, 2006”.

According to a further embodiment of the invention (a) the first power saving procedure belongs to a power saving class of a first type, of a second type or of a third type and/or (b) the second power saving procedure belongs to a power saving class of the first type, of the second type or of the third type. This may provide the advantage that not only power saving procedures being assigned to a particular type of power saving class (PSC) can be synchronized with each other but also power saving procedures being assigned to different types of power saving classes can be synchronized with each other. Therefore, the described MS operating method can be used for a wide variety of power management approaches, which may be used in connection with different radio telecommunication networks.

In particular, the described MS operating method can be carried out in the above described WiMax telecommunication network, which according to its standard specification comprises three types of PSC, which differ by their parameter sets, procedures of MS activation and deactivation and policies of availability of the MS for data transmission. These three types of PSC have already been described above in the chapter “art background”. In order to avoid unnecessary recurrences reference is made to the above description of A) PSC of type I, B) PSC of type I and C) PSC of type III.

In this respect it is mentioned that the power saving procedure, which might belong to any type of power saving class, is typically designed based on the current data connections between the MS and the serving BS while an energy saving procedure is executed by the MS. Since initially, i.e. before the described method is carried out, the time distributions of the listening window and sleep windows are independent among different PSCs, the actual duration of the unavailability interval of the MS depends on the overlapping of sleep windows of all power saving procedures. Therefore, by properly adjusting respectively by properly synchronizing different power saving procedures, the unavailability interval of the MS can be significantly increased in most cases. As a consequence, the power consumption of the MS can be decreased. Thereby, performance requirements with respect to the data transmission rates of the MS can be guaranteed.

According to a further embodiment of the invention (a) the first power saving procedure is assigned to an unsolicited grant service connection, to an extended real-time variable rate service connection or to a real-time variable rate service connection of the mobile station and/or (b) the second power saving procedure is assigned to a further unsolicited grant service connection, to a further extended real-time variable rate service connection or to a further real-time variable rate service connection of the mobile station.

According to the above mentioned specification IEEE 802.16e-2005, the unsolicited grant service (UGS) and also the extended real-time variable rate service (ERT-VR) connection and the real-time variable rate service (RT-VR) connection are related to a PSC of type II.

Different UGS connections may have for instance different qualify of service (QoS) parameters. Therefore, different UGS connections may usually belong to different power saving procedures within the PSC of type II.

Considering the practical QoS category in reality, it may be advantageous to select the periodical polling interval of UGS from a special time interval series in which the following number respectively the following time length is always dividable evenly by the forgoing number respectively the forgoing time length. Such a behavior can be described for instance by the series (a₁, a₁•a₂, a₁•a₂•a₃, a₁•a₂•a₃•a₄, . . . ). Thereby, the special series with the smallest grid would be a power series with base “two”.

In this respect it is noted that in this application listening windows (LW), sleep windows (SW) and other related interval lengths are all represented in the units of a frame, which represents an elementary time interval for time division multiplexing. Therefore, the listening window (LW) and sleep window (SW) could be determined by the following equations:

$$LW = \frac{λ \cdot l \cdot Interval \cdot T}{{b}_{grant}} \\ SW = Interval - LW \\ Interval = {2}^{n} ( n = 1 , 2 , 3 … ) \qquad ( 1 )$$

Thereby, λ and l denote the packet arrival rate and packet length from the upper Open Systems Interconnection (OSI) layer. Interval denotes the unsolicited polling interval in frames and T denotes the frame duration. b_{grant} denotes the grant size respectively the granted bytes for the particular UGS connection per frame.

According to a further embodiment of the invention the method further comprises (a) setting up the unsolicited grant service connection being assigned to the first power saving procedure and (b) synchronizing the start times of the first listening windows of the first power saving procedure (b1) with the start times of the second listening windows of the second power saving procedure, in case the second power saving procedure is assigned to an already existing further unsolicited grant service connection or further extended real-time variable rate service connection or (b2) with a polling interval of an already existing further real-time variable rate service connection.

Generally speaking, when a new UGS connection is set up for the MS, which is currently involved in a sleep mode management, the MS should check if there are currently activated any power saving procedures belonging to a PSC of type II and being for instance assigned to UGS, ERT-VR or RT-VR running on the same MS. During negotiation of the sleep mode parameter for this new UGS connection, the BS and MS have to define the start time of the corresponding listening windows synchronized with the existing UGS or ERT-VR connections or with the start time of the polling interval of the existing RT-VR connections. Since the listening windows and the sleep windows are constant all through the sleep mode operation and the larger interval length corresponding to the sum of the durations of a listening window and a sleep window is always divided evenly by the smaller interval length, as long as the first listening window of the new PSC is synchronized with the existing ones, automatically all the following series of sleep windows will be well overlapped.

According to a further embodiment of the invention at least one of the first and the second power saving procedure is assigned to an extended real-time variable rate service connection, which is dynamically changing its grant size. This may provide the advantage that for ERT-VR the described method provides an effective measure for reducing the MS power consumption.

It has to be mentioned that when dynamically changing the grant size for the ERT-VR connection the unsolicited grant in fixed periodical intervals can be kept the same.

According to a further embodiment of the invention at least one of the first and the second power saving procedure is assigned to a real-time variable rate service connection, wherein the polling interval of the real-time variable rate service connection is selected from a time interval series in which the duration of a subsequent time interval is always dividable evenly by the duration of a preceding time interval.

As has already been mentioned above, such a behavior can be described for instance by the series (a₁, a₁•a₂, a₁•a₂•a₃, a₁•a₂•a₃•a₄, . . . ). Thereby, the special series with the smallest grid would be a power series with base “two”.

Generally speaking, the polling interval for RT-VR service is an important parameter. In the uplink direction, as long as the polling interval arrives, the BS polls the MS for sending bandwidth request indicating the required resource and grants the allocated slots in the next frames. Therefore, it is preferably if the polling interval for RT-VR should also follow the definition rule as the unsolicited polling interval for UGS and/or ERT-VR, i.e. a series of multipliers for the same base. In this way, the described method is also feasible for RT-VR service.

According to a further embodiment of the invention at least one of the first and the second power saving procedure is assigned to a best effort service connection or to a non-real-time variable rate service of the mobile station.

All best effort service (BE) and non-real-time variable rate service (NRT-VR) connections may be marked as belonging to a single class of PSC of type I. According to the above mentioned specification IEEE 802.16e-2005, the listening windows of a PSC of type I are fixed while the sleep windows are set as follows:

SW₁=SWᵢₙᵢ

SWₖ=min(2·SWₖ₋₁,SW_{fin}),k≧2 (2)

Thereby, SWₖ denotes the kth sleep window size, SWᵢₙᵢ denotes the initial sleep window size and SW_{fin} denotes the final sleep window size. In order to make the PSC of type I synchronized with already existing power saving classes, the onset of the PSC of type I sleep mode operation can be accomplished as follows:

a) The state transfer from a sleep window to a listening window can be triggered either by the expiration of its sleep window (as defined in the above mentioned standard) or by the event that there is another parallel power saving class on the same MS entering a listening window or being deactivated from the sleep mode.
b) If the power saving class enters a listening window before the expiration of its sleep window, the ratio r between the real length of the last ending sleep window and the predefined length of the sleep window should be calculated.

The next sleep window can then be determined in the following way:

SW₁=SWᵢₙᵢ

if (condition:r<0.5)

SWₖ=SWₖ₋₁

else

SWₖ=min(2·SWₖ₋₁,SW_{fin}),k≧2 (3)

Descriptive speaking, with the introduction of the condition for the ratio r the doubling of the sleep windows will be stopped earlier.

According to a further embodiment of the invention at least one of the first and the second power saving procedure is assigned to a multicast service connection or to a management operation connection of the mobile station.

As has already been mentioned above, a PSC of type III is recommended for multicast connections as well as for management message operations. This type of PSC has no listening window and the deactivation of the respective power saving mode occurs automatically after the expiration of a sleep window. During the sleep window of a power saving procedure of the PSC of type III, if there is any other power saving class belonging to the same MS and entering a listening window or deactivating from sleep mode, the sleep window of the power saving procedure of the PSC of the type III can be terminated without waiting for its expiration. In this way, the availability interval of the PSC III could be well matched with the availability interval of power saving procedures being assigned to other types of PSC.

According to a further aspect of the invention there is provided a mobile station for a telecommunication network. The mobile station comprises (a) a unit for storing first parameters of a first power saving procedure for the mobile station, wherein the first power saving procedure comprises an alternating sequence of first sleep windows and first listening windows, (b) a unit for storing second parameters of a second power saving procedure for the mobile station, wherein the second power saving procedure comprises an alternating sequence of second sleep windows and second listening windows, (c) a unit for adjusting on the time axis the first sleep windows and the second sleep windows with respect to each other in such a manner, that a time overlap between the first sleep windows and the second sleep windows is increased.

The described mobile station may be adapted to carry out any embodiment of the above described mobile station operating method. By carrying out this method, all power saving procedures, which might belong to the same or to different types of PSC and which are executed by the same MS can be operated in a synchronized alignment. With well defined cycles of sleep window and listening window intersection, the unavailable interval of the MS can be increased or even maximized and the electric power consumption of the MS can be reduced.

According to a further aspect of the invention there is provided a base station for a telecommunication network. The base station comprises (a) a unit for storing first parameters of a first power saving procedure for a mobile station of the telecommunication network, wherein the first power saving procedure comprises an alternating sequence of first sleep windows and first listening windows, (b) a unit for storing second parameters of a second power saving procedure for the mobile station, wherein the second power saving procedure comprises an alternating sequence of second sleep windows and second listening windows, and a unit for adjusting on the time axis the first sleep windows and the second sleep windows with respect to each other in such a manner, that a time overlap between the first sleep windows and the second sleep windows is increased.

Also the described base station (BS) may be adapted to carry out any embodiment of the above described method for operating a mobile station (MS). Thereby, of course the step of operating the MS is not in the sphere of influence of the BS. Therefore, this step will not be carried out by the MS, but the BS station may be able to trigger the MS to operate in the adjusted mode, which is defined by the increased time overlap between the first sleep windows and the second sleep windows.

According to a further aspect of the invention there is provided a program element for operating a mobile station within a telecommunication network. The program element, when being executed by a data processor, is adapted for controlling the method according any embodiment as described above.

As used herein, reference to a program element is intended to be equivalent to a reference to a computer program and/or to a computer readable medium containing instructions for controlling a computer system to coordinate the performance of the above described method.

The computer program element may be implemented as computer readable instruction code in any suitable programming language, such as, for example, JAVA, C++, and may be stored on a computer-readable medium (removable disk, volatile or non-volatile memory, embedded memory/processor, etc.). The instruction code is operable to program a computer or other programmable device to carry out the intended functions. The computer program may be available from a network, such as the WorldWideWeb, from which it may be downloaded.

The invention may be realized by means of a computer program respectively software. However, the invention may also be realized by means of one or more specific electronic circuits respectively hardware. Furthermore, the invention may also be realized in a hybrid form, i.e. in a combination of software modules and hardware modules.

It has to be noted that embodiments of the invention have been described with reference to different subject matters.

In particular, some embodiments have been described with reference to method type claims whereas other embodiments have been described with reference to apparatus type claims. However, a person skilled in the art will gather from the above and the following description that, unless other notified, in addition to any combination of features belonging to one type of subject matter also any combination between features relating to different subject matters, in particular between features of the method type claims and features of the apparatus type claims is considered as to be disclosed with this application.

The aspects defined above and further aspects of the present invention are apparent from the examples of embodiment to be described hereinafter and are explained with reference to the examples of embodiment. The invention will be described in more detail hereinafter with reference to examples of embodiment but to which the invention is not limited.

### BRIEF DESCRIPTION OF THE DRAWINGS

FIG. 1a shows a timing diagram depicting the time overlap between first and second sleep windows being assigned to different power saving procedures, which are both assigned to an unsolicited grant service, before an adjustment procedure in accordance with the invention has been carried out.

FIG. 1b shows a timing diagram depicting the time overlap between first and second sleep windows being assigned to different power saving procedures, which are both assigned to an unsolicited grant service, after an adjustment procedure in accordance with the invention has been carried out.

FIG. 2a shows a timing diagram depicting the time overlap between first and second sleep windows being assigned to power saving procedures of a first and a second type of power saving class, respectively, before an adjustment procedure in accordance with the invention has been carried out.

FIG. 2b shows a timing diagram depicting the time overlap between first and second sleep windows being assigned to power saving procedures of a first and a second type of power saving class, respectively, after an adjustment procedure in accordance with the invention has been carried out.

FIG. 3 shows a mobile station in accordance with the present invention.

FIG. 4 shows a base station in accordance with the present invention.

### DETAILED DESCRIPTION

The illustration in the drawing is schematically. It is noted that in different figures, similar or identical elements are provided with the same reference signs or with reference signs, which are different from the corresponding reference signs only within the first digit.

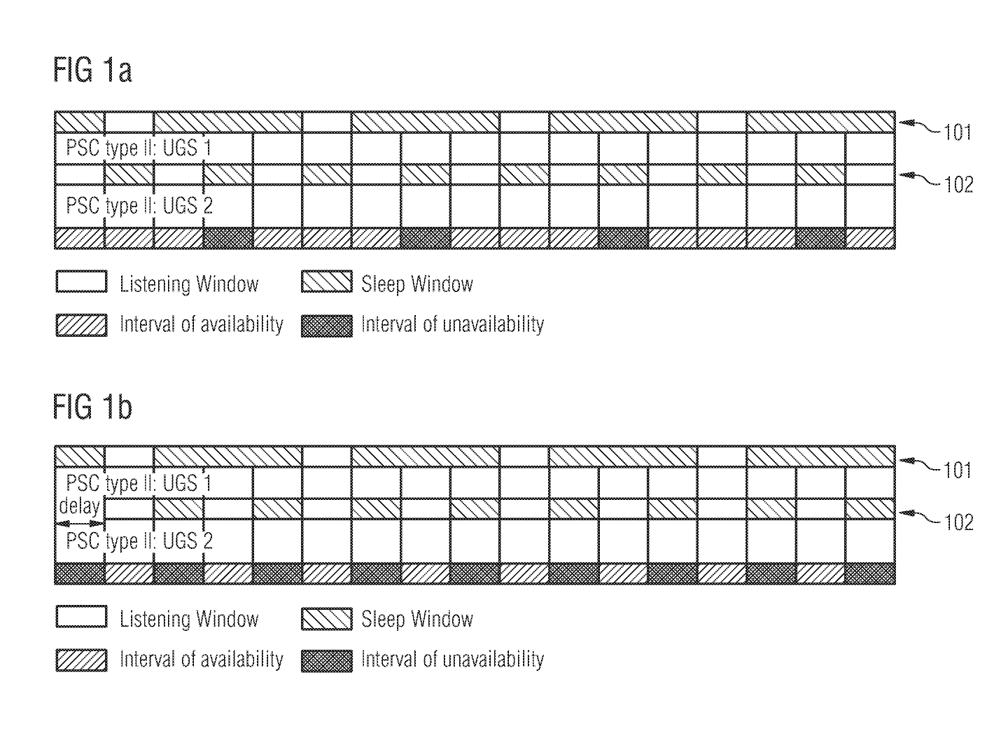

FIG. 1a shows an example of a normal sleep mode operation with two unsolicited grant service (UGS) connections on one mobile station (MS). It is assumed that a first unsolicited grant service connection UGS1 has been established prior to a second unsolicited grant service connection UGS2. This means that the second unsolicited grant service connection UGS2 is a new connection built up on this MS in the presence of the already established first unsolicited grant service connection UGS 1.

A first power saving procedure 101 being assigned to the first unsolicited grant service connection UGS1 comprises listening windows (LW) and sleep windows (SW), which are marked as indicated in the explaining legend of FIG. 1a. The same holds for a second power saving procedure 102 being assigned to the second unsolicited grant service connection UGS2.

In the bottom line of FIG. 1a there are depicted the intervals of availability and the intervals of unavailability of the MS. These time intervals are also marked as indicated in the explaining legend of FIG. 1a. As has already been described above, a MS will only be unavailable within a time interval, which is defined by the time overlap between two sleep windows.

As can be seen from FIG. 1a, the listening windows from the different connections are not synchronized. Therefore, the achieved unavailability interval length is limited. As a consequence, the reduction of the power consumption of the MS is relatively small.

FIG. 1b shows an example of an adjusted sleep mode operation with the two unsolicited grant service connection UGS1 and UGS2. Thereby, the time structure of the second power saving procedure 102 being assigned to the second unsolicited grant service connection UGS2 has been shifted with respect to the time structure of the first power saving procedure 101 being assigned to the first unsolicited grant service connection UGS1. This is indicated in FIG. 1b by the double arrow which is marked with “delay”.

As can be seen from FIG. 1b, the time shift of the second power saving procedure 102 causes a significantly increase in the time overlap between the first sleep windows being assigned to the first power saving procedure 101 and the second sleep windows being assigned to the second power saving procedure 102. As a consequence, the MS will be unavailable much longer and the power saving potential is significantly enhanced.

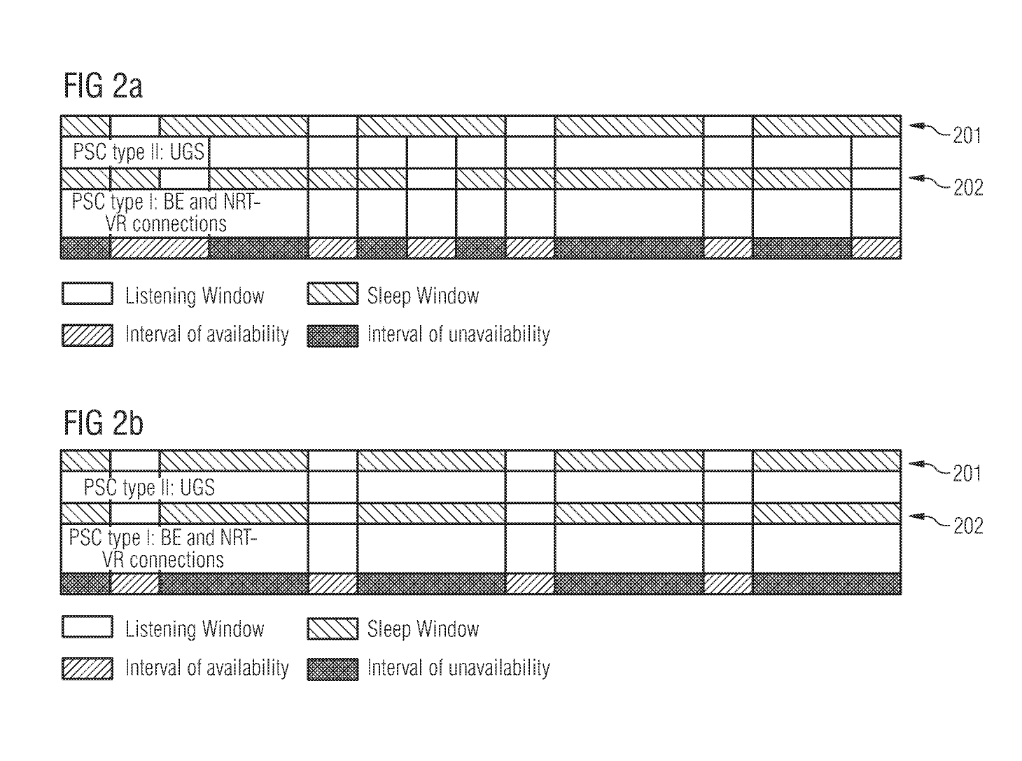

FIGS. 2a and 2b show an example of comparing the normal operation mode and an adjusted operation mode, wherein a first power saving procedure 201 is assigned to a power saving class (PSC) of type II and a second power saving procedure 202 is assigned to a power saving class (PSC) of type I. The improvement of power saving is obvious based on better overlapping of the time intervals of the respective sleep windows by synchronizing the first listening windows of the first power saving procedure 201 and the second listening windows of the second power saving procedure 202, respectively.

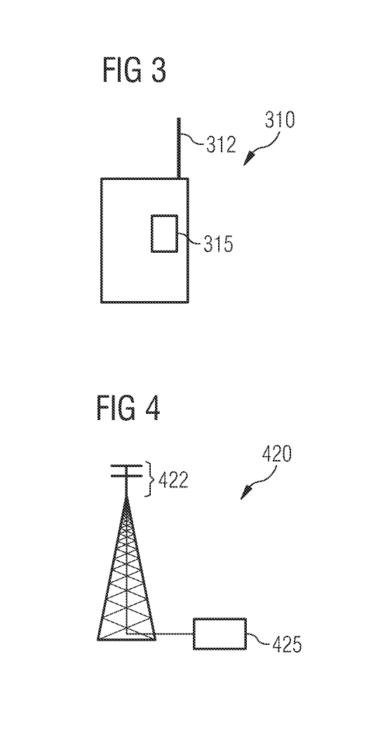

FIG. 3 shows a mobile station 312, which is adapted to accomplish the above described method for cycle synchronizing different power saving procedures. According to the embodiment described here the mobile station is a cellular phone 312. However, it is mentioned that the mobile station may be any type of communication end device, which is capable of connecting with a base station of a telecommunication network. The mobile station may also be a Personal Digital Assistant (PDA), a notebook computer and/or any other movable communication device.

The mobile station 312 comprises an antenna 312 for transmitting the radio signals to a serving base station and for receiving radio signals from the serving base station.

Further, the mobile station 312 comprises an adjustment unit 315 for adjusting on the time axis first sleep windows being assigned to a first power saving procedure and second sleep windows being assigned to a second power saving procedure with respect to each other in such a manner, that a time overlap between the first sleep windows and the second sleep windows is maximized.

FIG. 4 shows a base station 420 according to an embodiment of the present invention.

The base station 420 comprises an antenna 422 for receiving the radio signals from a mobile station being served by the base station 420 and for transmitting radio signals to the served mobile station.

Further, the base station 420 comprises an adjustment unit 425 for adjusting on the time axis first sleep windows being assigned to a first power saving procedure and second sleep windows being assigned to a second power saving procedure with respect to each other in such a manner, that a time overlap between the first sleep windows and the second sleep windows is maximized.

It should be noted that the term “comprising” does not exclude other elements or steps and “a” or “an” does not exclude a plurality. Also elements described in association with different embodiments may be combined. It should also be noted that reference signs in the claims should not be construed as limiting the scope of the claims.

### LIST OF REFERENCE SIGNS

101 first power saving procedure
102 second power saving procedure
PSC power saving class
UGS1 first unsolicited grant service connection
UGS2 second unsolicited grant service connection
201 first power saving procedure
202 second power saving procedure
PSC power saving class
UGS unsolicited grant service connection
BE best effort service
NRT-VR non-real-time variable rate service
310 mobile station
312 antenna
315 adjustment unit
420 base station
422 antenna
425 adjustment unit

### LIST OF ABBREVIATIONS

BE best effort service
BS base station
DL downlink
ertPS extended real-time polling service
ERT-VR extended real-time variable rate service
LW listening window
MS Mobile Station
NRT-VR non-real-time variable rate service
PSC power saving class
rtPS real-time polling service
RT-VR real-time variable rate service
SW sleep window
UGS unsolicited grant service
UL uplink
WiMax Worldwide Interoperability for Microwave Access

1. Method for operating a mobile station within a telecommunication network, the method comprising
providing a first power saving procedure for the mobile station, wherein the first power saving procedure comprises an alternating sequence of first sleep windows and first listening windows,
providing a second power saving procedure for the mobile station wherein the second power saving procedure comprises an alternating sequence of second sleep windows and second listening windows,
adjusting on the time axis the first sleep windows and the second sleep windows with respect to each other in such a manner, that a time overlap between the first sleep windows and the second sleep windows is increased, and
operating the mobile station in an adjusted mode, which is defined by the increased time overlap.

2. The method as set forth in claim 1, wherein the time overlap between the first sleep windows and the second sleep windows is maximized.

3. The method as set forth in claim 1, wherein a first quality of service requirement for a first data delivery service being associated with the first power saving procedure and/or a second quality of service requirement for a second data delivery service being associated with the second power saving procedure is taken into account when adjusting on the time axis the first sleep windows and the second sleep windows with respect to each other.

4. The method as set forth in claim 1, further comprising
providing at least one further power saving procedure for the mobile station, wherein the further power saving procedure comprises an alternating sequence of further sleep windows and further listening windows,
wherein
on the time axis the first sleep windows, the second sleep windows and the further sleep windows are adjusted with respect to each other in such a manner, that a time overlap between the first sleep windows, the second sleep windows and the further sleep windows is increased.

5. The method as set forth in claim 1, wherein the telecommunication network is a Worldwide Interoperability for Microwave Access telecommunication network.

6. The method as set forth in claim 1, wherein the first power saving procedure belongs to a power saving class of a first type, of a second type or of a third type and/or the second power saving procedure belongs to a power saving class of the first type, of the second type or of the third type.

7. The method as set forth claim 1, wherein
the first power saving procedure is assigned to
an unsolicited grant service connection,
an extended real-time variable rate service connection or
a real-time variable rate service connection of the mobile station
and/or
the second power saving procedure is assigned to
a further unsolicited grant service connection,
a further extended real-time variable rate service connection or
a further real-time variable rate service connection of the mobile station.

8. The method as set forth in claim 1, further comprising
setting up the unsolicited grant service connection being assigned to the first power saving procedure and
synchronizing the start times of the first listening windows of the first power saving procedure
with the start times of the second listening windows of the second power saving procedure, in case the second power saving procedure is assigned to an already existing further unsolicited grant service connection or further extended real-time variable rate service connection or
with a polling interval of an already existing further real-time variable rate service connection.

9. The method as set forth in claim 7, wherein at least one of the first and the second power saving procedure is assigned to an extended real-time variable rate service connection, which is dynamically changing its grant size.

10. The method as set forth in claim 7, wherein at least one of the first and the second power saving procedure is assigned to a real-time variable rate service connection, wherein the polling interval of the realtime variable rate service connection is selected from a time interval series in which the duration of a subsequent time interval is always dividable evenly by the duration of a preceding time interval.

11. The method as set forth in claim 6, wherein
at least one of the first power saving procedure and the second power saving procedure is assigned to
a best effort service connection or
a non-real-time variable rate service of the mobile station.

12. The method as set forth in claim 6, wherein
at least one of the first power saving procedure and the second power saving procedure is assigned to
a multicast service connection or
a management operation connection of the mobile station.

13. A mobile station for a telecommunication network, the mobile station comprising
a unit for storing first parameters of a first power saving procedure for the mobile station, wherein the first power saving procedure comprises an alternating sequence of first sleep windows and first listening windows,
a unit for storing second parameters of a second power saving procedure for the mobile station, wherein the second power saving procedure comprises an alternating sequence of second sleep windows and second listening windows, and
a unit for adjusting on the time axis the first sleep windows and the second sleep windows with respect to each other in such a manner, that a time overlap between the first sleep windows and the second sleep windows is increased.

14. A base station for a telecommunication network, the base station comprising
a unit for storing first parameters of a first power saving procedure for a mobile station of the telecommunication network, wherein the first power saving procedure comprises an alternating sequence of first sleep windows and first listening windows,
a unit for storing second parameters of a second power saving procedure for the mobile station, wherein the second power saving procedure comprises an alternating sequence of second sleep windows and second listening windows, and
a unit for adjusting on the time axis the first sleep windows and the second sleep windows with respect to each other in such a manner, that a time overlap between the first sleep windows and the second sleep windows is increased.

15. A program element for operating a mobile station within a telecommunication network, the program element, when being executed by a data processor, is adapted for controlling the method as set forth in claim 1.
